(19) United States
(12) Patent Application Publication
(10) Pub. No.: US 2013/0002722 A1
(43) Pub. Date: Jan. 3, 2013

(54) ADAPTIVE TEXT FONT AND IMAGE ADJUSTMENTS IN SMART HANDHELD DEVICES FOR IMPROVED USABILITY

(76) Inventors: Yuri I. Krimon, Folsom, CA (US); David I. Poisner, Carmichael, CA (US)

(21) Appl. No.: 13/175,402

(22) Filed: Jul. 1, 2011

(51) Int. Cl. G09G 5/00

(52) U.S. Cl. 345/661

(57) ABSTRACT

Systems and methods of operating a system may involve obtaining an image from a front-facing camera of the system, and conducting a facial distance analysis on the image. In addition, a visualization characteristic of display content associated with the system may be modified based at least in part on the facial distance analysis.

### BACKGROUND

1. Technical Field

Embodiments generally relate to display usability in consumer electronic devices. More particularly, embodiments relate to adaptive display adjustments in devices for improved usability.

2. Discussion

Individuals may use handheld devices throughout the day under a variety of conditions, wherein the distance between a handheld device display and a user's eyes can vary. In order to comfortably view display content, a user may need to navigate through a setup screen, put on glasses, press buttons and/or manually manipulate the display (e.g., in the case of touch screen devices). These activities could have a negative impact on device usability from the user's perspective.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a handheld device having both a front-facing camera and a rear-facing camera according to an embodiment;

FIG. 2 is a block diagram of an example of a facial distance analysis according to an embodiment;

FIGS. 3A and 3B are diagrams of examples of relative facial feature measurements according to an embodiment;

FIG. 4A is a flowchart of an example of a method of conducting a calibration according to an embodiment;

FIG. 4B is a flowchart of an example of a method of conducting a real-time facial distance analysis according to an embodiment;

FIG. 5 is a block diagram of an example of a text visualization characteristic modification according to an embodiment; and

FIG. 6 is a block diagram of an example of a mobile platform according to an embodiment.

### DETAILED DESCRIPTION

Embodiments may include a mobile platform having a front-facing camera to obtain an image, a display to output display content, and logic to conduct a facial distance analysis on the image. The logic may also modify a visualization characteristic of the display content based at least in part on the facial distance analysis.

Embodiments may also include an apparatus having logic to obtain an image from a front-facing camera of a mobile platform, and conduct a facial distance analysis on the image. The logic can also modify a visualization characteristic of display content associated with the mobile platform based at least in part on the facial distance analysis.

Other embodiments may include a non-transitory computer readable storage medium having a set of instructions which, if executed by a processor, cause a mobile platform to obtain an image from a front-facing camera of the mobile platform. The instructions can also cause the mobile platform to conduct a facial distance analysis on the image, and modify a visualization characteristic of display content associated with the mobile platform based at least in part on the facial distance analysis.

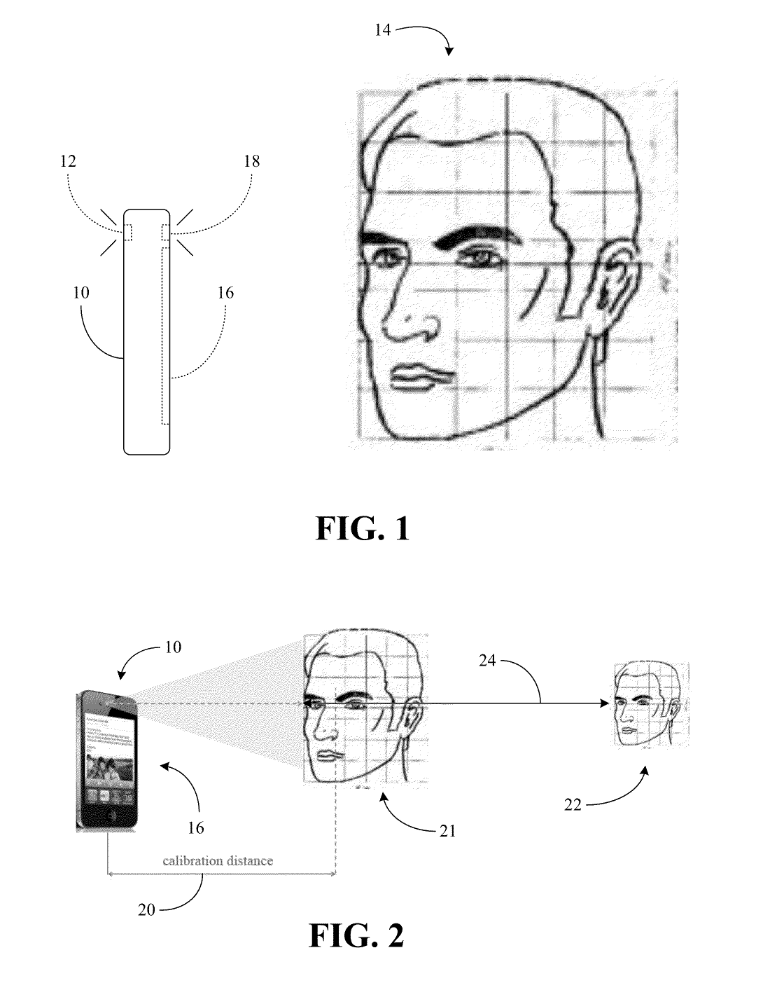

Turning now to FIG. 1, a handheld device 10 is shown. The illustrated handheld device 10 has a rear-facing camera 12 configured to capture photos and/or videos of various subjects of interest to a user 14. The handheld device 10 may also include a display 16 configured to output display content that might include text, images and other content, depending upon the software applications installed thereon and/or other functionality of the handheld device 10. Indeed, the display content may readily include the images and/or videos captured by the rear-facing camera 12 as well as images and/or videos obtained over a network connection (e.g., video conferencing feed). As will be discussed in greater detail, the handheld device 10 could also be another type of mobile platform such as a laptop, mobile Internet device (MID), smart tablet, personal digital assistant (PDA), wireless smart phone, media player, imaging device, etc., or a fixed platform such as a smart television (TV), liquid crystal display (LCD) panel, desktop personal computer (PC), server, workstation, etc.

In the illustrated example, the handheld device 10 also includes a front-facing camera 18 that may also be configured to capture images and videos and display the captured content on the display 16. In particular, the front-facing camera 18 might be used to record the user 14 during video conferencing sessions with other individuals. As will be discussed in greater detail, the images of the user 14 captured by the front-facing camera 18 may also be used to adapt the display content that is output via the display 16 in real-time to make the content more readable to the user 14.

FIG. 2 demonstrates that a calibration of the mobile device 10 can be conducted in order to determine a calibration facial distance 20 and one or more calibration display settings for a calibration image 21, wherein subsequent real-time facial distance determinations may be made relative to the calibration facial distance 20. As will be discussed in greater detail, the calibration facial distance 20 could represent the distance between the user and the handheld device 10, or a facial feature distance such as the width/height of the user's head, the width/diameter of the user's eyes or the distance between the user's eyes during calibration. Moreover, distance may be measured in pixels, inches, centimeters, etc., depending upon the circumstances.

The real-time facial distance determinations can be used to modify text visualization characteristics (e.g., text height, font, etc.) as well as other visualization characteristics such as display intensity, the amount of display content, and so forth. For example, the calibration facial distance 20 might be associated with a certain text size (e.g., 14-point size) that is comfortable to the user at that distance 20, wherein upon determining that a subsequent real-time image 22 taken of the user corresponds to a certain distance 24 farther away from the mobile device 10 than the user was at the time of the calibration image 21, the text size of the display content may be increased proportionately to ensure that it is still comfortably visible to the user. In addition, the display intensity (e.g., backlight brightness) might be increased to improve visibility, the amount of display content shown could be reduced to account for the additional screen area taken up by the larger text, and so forth.

Similarly, if it is determined that the facial distance determination and calibration facial distance 20 indicate that the user is closer to the display 16, the text size could be decreased, the display intensity could be decreased, the amount of display content shown could be increased, and so forth. Other visualization characteristics may also be adjusted on-the-fly as appropriate. Indeed, the mobile device 10 can also detect eyewear in the image and optionally bypass and/or further adapt visualization characteristic modifications while the eyewear is present. For example, the handheld device 10 could be calibrated for the user with and without eyewear, so that two sets of calibration display settings may be maintained and selectively accessed based on whether the user is wearing glasses. Accordingly, the illustrated approach may provide substantially more device usability from the user's perspective. Indeed, situations in which the display intensity can be automatically reduced may result in less power consumption and longer battery life for the handheld device 10.

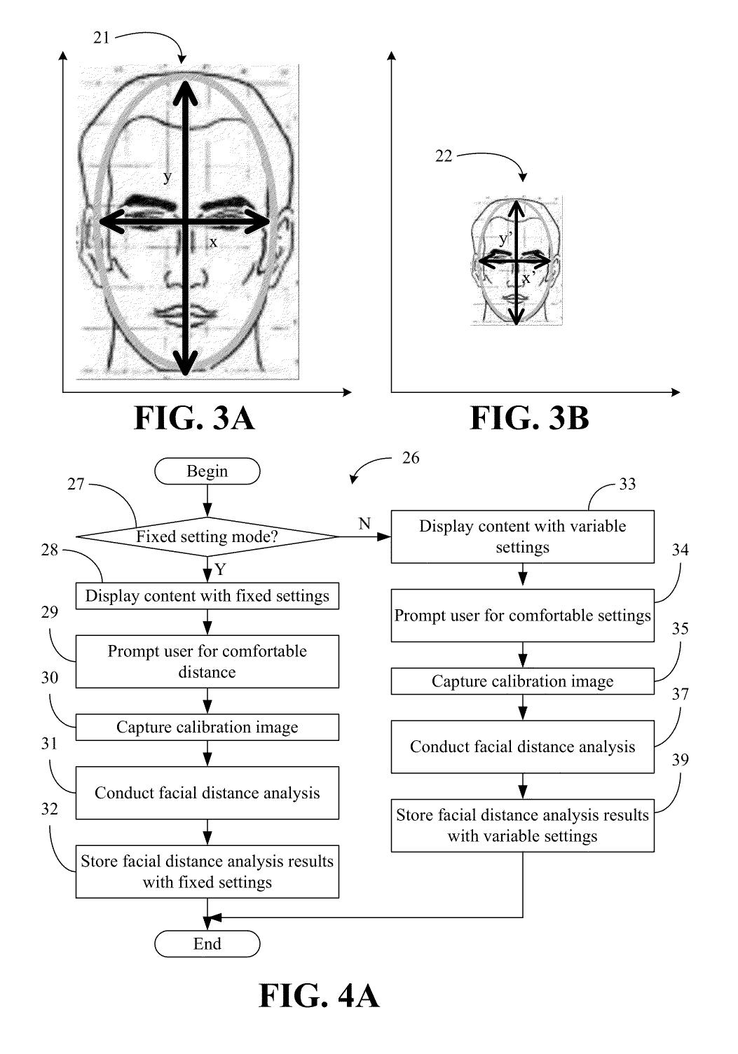

Turning now to FIGS. 3A and 3B, examples are shown of the types of facial features that may be used to make facial distance determinations for the subsequent real-time image 22 relative to the calibration image 21. For example, relative facial width (e.g., ratio of x to x′), facial height (e.g., ratio of y to y′), facial area (e.g., percent of pixel map occupied by the face), eye separation (e.g., distance between the eyes), etc., and/or combinations thereof, could all be used to determine facial distance. Thus, if the facial width (x) for the calibration image 21 is 100-pixels and the facial width (x′) for the real-time image 22 is 50-pixels, the ratio of x to x′ would be 2.0. The decision of which facial feature to use may be based on computational complexity so as to reduce processing overhead and increase speed. In this regard, the use of a camera to conduct the facial distance analysis may provide for the extraction of facial features that might not be discernable via other distance detection solutions such as infrared (IR) based solutions or ultrasonic based solutions. Moreover, the illustrated approach can enable operation from a limited amount of information, such as the outline of the face and/or center of the eyes, and may therefore eliminate any need for full facial recognition and its associated processing overhead. Additionally, such a streamlined approach to facial distance analysis can allow for higher tolerance of camera misalignment (e.g., when the camera is not pointed directly at the user's face).

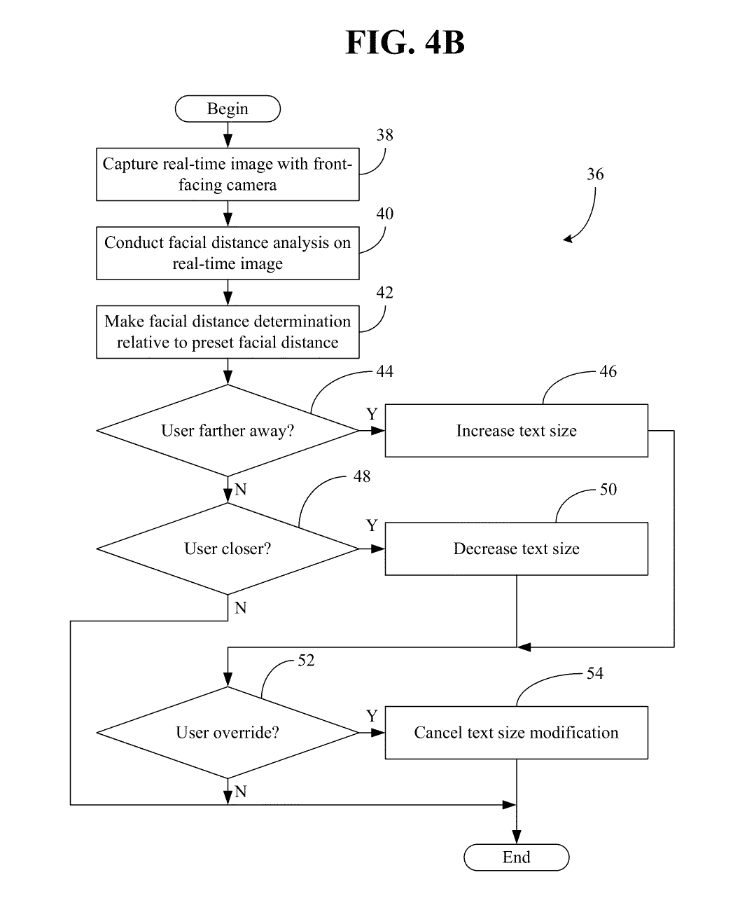

FIG. 4A shows a method 26 of conducting a calibration. The method 26 may be implemented in executable software as a set of logic instructions stored in a machine- or computer-readable medium such as random access memory (RAM), read only memory (ROM), programmable ROM (PROM), firmware, flash memory, etc., in fixed-functionality logic hardware using circuit technology such as application specific integrated circuit (ASIC), complementary metal oxide semiconductor (CMOS) or transistor-transistor logic (TTL) technology, or any combination thereof. For example, computer program code to carry out operations shown in method 26 may be written in any combination of one or more programming languages, including an object oriented programming language such as Java, Smalltalk, C++ or the like and conventional procedural programming languages, such as the “C” programming language or similar programming languages.

Processing block 27 provides for determining whether a system having a front-facing camera is in a fixed setting mode. If so, illustrated block 28 outputs display content having fixed settings such as a fixed font size, display intensity and/or amount of display content. The user may then be prompted at block 29 to position the system at a comfortable distance from a viewing standpoint. Thus, in the case of a handheld device, the user might move the device to a certain distance from the user's eyes. In the case of a fixed platform such as smart TV, on the other hand, the user could sit or stand at a comfortable viewing distance from the display of the fixed platform. Block 30 may provide for capturing a calibration image of the user at the comfortable distance, wherein illustrated block 31 conducts a facial distance analysis on the calibration image. For example, the facial distance analysis could involve determining one or more calibration facial distances such as the distance between the eyes of the user, the width of the user's face, the height of the users face, the two-dimensional area of the user's face, the width of the user's eyes, and so on. The results of the facial distance analysis may be stored at block 32, along with the fixed settings of the display content, to a suitable storage location for later retrieval during real-time processing of captured images.

If it is determined at block 27 that the system is not in a fixed setting mode, the illustrated approach provides for the use of a variable setting mode during calibration. In particular, block 33 may provide for outputting display content having variable settings such as a variable font size, display intensity and/or amount of display content. Accordingly, the user can be prompted at block 34 to position the system at an arbitrary distance and select display settings that are comfortable from a viewing standpoint. Thus, in the case of a handheld device, the user might position the device at an arbitrary distance from the user's eyes and select the most comfortable font size, display intensity, amount of display content, and so forth. Block 35 may provide for capturing a calibration image of the user, wherein illustrated block 37 conducts a facial distance analysis on the calibration image. As already noted, the facial distance analysis could involve determining one or more calibration facial distances, wherein the results of the facial distance analysis and the selected variable settings can be stored for later retrieval at block 39.

FIG. 4B shows a method 36 of adapting text size based on real-time facial distance analyses. The method 36 may be implemented in executable software as a set of logic instructions stored in a machine- or computer-readable medium such as RAM, ROM, PROM, firmware, flash memory, etc., in fixed-functionality logic hardware (e.g., camera pipelines) using circuit technology such as ASIC, CMOS or TTL technology, or any combination thereof. Processing block 38 provides for capturing a real-time image with a front-facing camera of a mobile platform. The image capture frequency may be fixed or programmable, depending on various considerations such as battery life, screen update rate, user preference, etc. A facial distance analysis may be conducted on the real-time image at block 40, wherein illustrated block 42 makes a facial distance determination relative to a calibration facial distance. The relative facial distance determination could take into consideration facial features such as facial width, facial height, facial area, eye separation, etc., as already discussed.

Illustrated block 44 determines whether the facial distance determination and calibration facial distance indicate that the user has moved farther away from the display of the mobile platform (e.g., relative to the calibration facial distance). For example, the eye separation identified in the real-time image could be less than a calibration eye separation or the facial width identified in the real-time image could be less than a calibration facial width. If so, it may be inferred that the display content is more difficult for the user to view, and block 46 therefore increases the text size of the display content relative to the calibration text size.

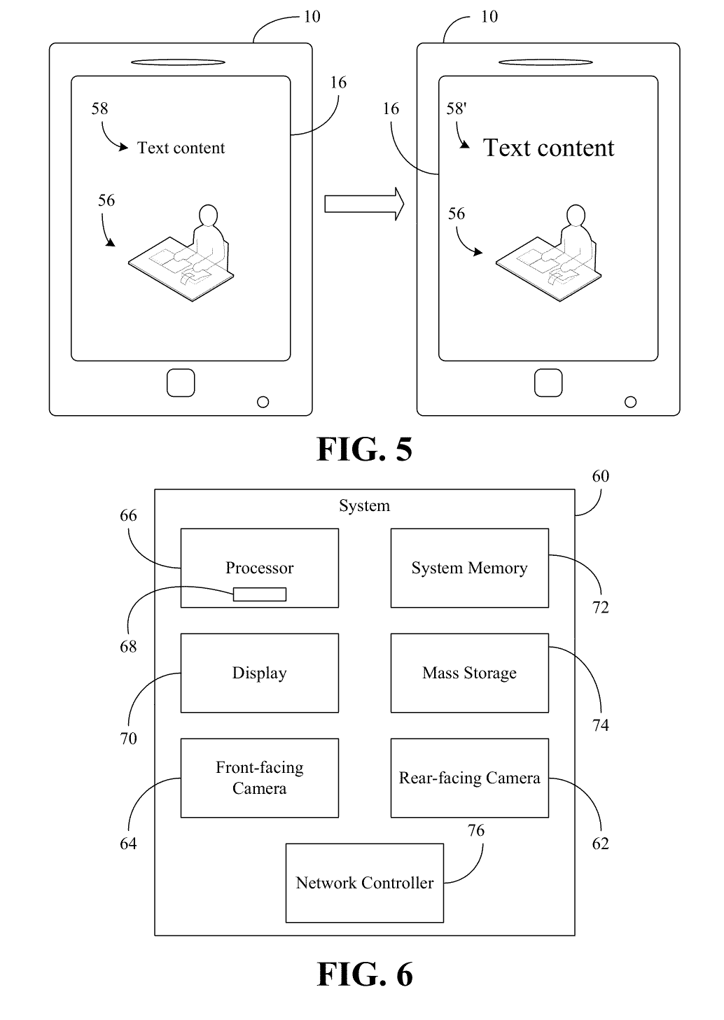

For example, FIG. 5 shows a handheld device 10 having a display 16 that originally outputs image content 56 and text content 58 at a first text size. Upon determining that the user is farther away from the display 16, the handheld device 10 automatically increases the text size so that the text content 58′ is greater. In the illustrated example, the image content 56 is kept the same, but the image content 56 may also be increased depending upon the circumstances. The amount of the increase may be proportional so that, for example, if the facial width ratio for the calibration image 21 (FIG. 3A) to the real-time image 22 (FIG. 3B) is x:x′, the text size can be increased by the same ratio. Thus, in the above example of a relative facial width ratio of 2.0 (i.e., 100-pixels to 50-pixels), the text size might be doubled from the calibration setting (e.g., increased from 14-point to 28-point).

Returning now to FIG. 4B, if, on the other hand, it is determined from the facial distance determination and the calibration facial distance at block 48 that the user is closer to the display of the mobile platform, block 50 decreases the text size of the display content relative to the calibration text size because it may be inferred that the display content is less difficult for the user to view. Moreover, the text size modifications may be quantized at various levels in order to control sensitivity and the frequency of the text size modifications. Other adjustments, such as display intensity adjustments and display content adjustments, may also be made. For example, a caller identification (ID) splash screen could be adapted to display more details at closer proximities, and display only the caller's last name in a large font at farther distances from the user's eyes.

Illustrated block 52 provides for determining whether a user override of the adjustment has been encountered. The user override could be detected via a manual adjustment of the text (e.g., touch screen interaction) or other mechanism. In addition, the user override may be encountered prior to the image capture and/or facial distance analysis. If an override has been encountered, block 54 may provide for cancelling and/or bypassing the text size modification. Additionally, if eyewear is detected in the image (or if the user has manually selected an “eyewear mode” of operation), the facial distance analysis and text visualization characteristic modification may be adjusted and/or bypassed altogether. If the facial distance analysis indicates that the user has not moved either closer to or farther away from the display relative to the calibration facial distance, the illustrated method can ensure that the text size remains at the calibration state.

FIG. 6 shows a system 60 having a display 70 configured to output display content, a rear-facing camera 62 and a front-facing camera 64 configured to capture an image of a user of the system 60. The system 60 may be readily substituted for the handheld device 10 (FIGS. 1, 2 and 5), already discussed. Accordingly, the illustrated system 60 could be part of a mobile platform such as a laptop, MID, smart tablet, PDA, wireless smart phone, media player, imaging device, etc., or any combination thereof. The system 60 could also be part of a fixed platform such as a smart TV, LCD panel, desktop PC, server, workstation, etc., or any combination thereof. In the case of certain platforms such as a smart TV with a web browser or an LCD panel, the system 60 might not include a rear-facing camera 62. In particular, the system 60 may include a processor 66 configured to execute logic 68 to obtain images from the front-facing camera 64, conduct facial distance analyses on the images, and modify one or more visualization characteristics of the display content based at least in part on the facial distance analyses, as already discussed.

The logic 68 may be embedded in the processor 66, retrieved as a set of instructions from a memory device such as system memory 72, mass storage 74 (e.g., hard disk drive/HDD, optical disk, flash memory), other storage medium, or any combination thereof. The system memory 72 could include, for example, dynamic random access memory (DRAM) configured as a memory module such as a dual inline memory module (DIMM), a small outline DIMM (SODIMM), etc. The system 60 may also include a network controller 76, which could provide off-platform wireless communication functionality for a wide variety of purposes such as cellular telephone (e.g., W-CDMA (UMTS), CDMA2000 (IS-856/IS-2000), etc.), Wi-Fi (e.g., IEEE 802.11, 2007 Edition, LAN/MAN Wireless LANS), Low-Rate Wireless PAN (e.g., IEEE 802.15.4-2006, LR-WPAN), Bluetooth (e.g., IEEE 802.15.1-2005, Wireless Personal Area Networks), WiMax (e.g., IEEE 802.16-2004, LAN/MAN Broadband Wireless LANS), Global Positioning System (GPS), spread spectrum (e.g., 900 MHz), and other radio frequency (RF) telephony purposes. The network controller 76 could also provide off-platform wired communication (e.g., RS-232 (Electronic Industries Alliance/EIA), Ethernet (e.g., IEEE 802.3-2005, LAN/MAN CSMA/CD Access Method), power line communication (e.g., X10, IEEE P1675), USB (e.g., Universal Serial Bus 2.0 Specification), digital subscriber line (DSL), cable modem, T1 connection), etc., functionality. Thus, the display content may be obtained via the network controller 76.

Accordingly, a baseline or preset knowledge of a user's facial measurements may be leveraged to improve device usability from the user's perspective. Additionally, the use of camera-based distance detection enables the extraction of facial features that provide for more robust display operation over relatively long distances.

Embodiments described herein are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A non-transitory computer readable storage medium comprising a set of instructions which, if executed by a processor, cause a system to:
obtain an image associated with a front-facing camera of the system;
conduct a facial distance analysis on the image; and
modify a visualization characteristic of display content associated with the system based at least in part on the facial distance analysis.

2. The medium of claim 1, wherein the instructions, if executed, cause the system to:
identify one or more facial features in the image; and
make a facial distance determination based at least in part on the one or more facial features.

3. The medium of claim 2, wherein the instructions, if executed, cause the system to:
conduct a calibration of the system to obtain a calibration facial distance; and
store the calibration facial distance and one or more calibration display settings to a memory location, wherein the facial distance determination is to be made relative to the calibration facial distance.

4. The medium of claim 2, wherein the instructions, if executed, cause the system to increase a text size of the display content if the facial distance determination and a calibration facial distance indicate that a user is farther away from the display.

5. The medium of claim 2, wherein the instructions, if executed, cause the system to decrease a text size of the display content if the facial distance determination and the calibration facial distance indicate that a user is closer to the display.

6. The medium of claim 2, wherein the one or more facial features are to include at least one of a facial width, a facial height, a facial area, an eye width and an eye separation.

7. The medium of claim 1, wherein the instructions, if executed, cause the system to modify an amount of the display content based at least in part on the facial distance analysis.

8. The medium of claim 1, wherein the instructions, if executed, cause the system to modify a display intensity associated with the system based at least in part on the facial distance analysis.

9. The medium of claim 1, wherein the instructions, if executed, cause the system to:
detect eyewear in the image; and
adjust the visualization characteristic modification in response to detecting the eyewear.

10. The medium of claim 1, wherein the instructions, if executed, cause the system to:
receive a user override; and
cancel the visualization characteristic modification in response to the user override.

11. A system comprising:
a front-facing camera to obtain an image;
a display to output display content; and
logic to,
conduct a facial distance analysis on the image, and
modify a visualization characteristic of the display content based at least in part on the facial distance analysis.

12. The system of claim 11, wherein the logic is to,
identify one or more facial features in the image, and
make a facial distance determination based at least in part on the one or more facial features.

13. The system of claim 12, wherein the logic is to:
conduct a calibration of the system to obtain a calibration facial distance, and
store the calibration facial distance and one or more calibration display settings to a memory location, wherein the facial distance determination is to be made relative to the calibration facial distance.

14. The system of claim 12, wherein the logic is to increase a text size of the display content if the facial distance determination and a calibration facial distance indicate that a user is farther away from the display.

15. The system of claim 12, wherein the logic is to decrease a text size of the display content if the facial distance determination and a calibration facial distance indicate that a user is closer to the display.

16. The system of claim 12, wherein the one or more facial features are to include at least one of a facial width, a facial height, a facial area, an eye width and an eye separation.

17. The system of claim 11, wherein the logic is to modify an amount of the display content based at least in part on the facial distance analysis.

18. The system of claim 11, wherein the logic is to modify a display intensity associated with the system based at least in part on the facial distance analysis.

19. The system of claim 11, wherein the logic is to,
detect eyewear in the image, and
adjust the visualization characteristic modification in response to detecting the eyewear.

20. The system of claim 11, wherein the logic is to,
receive a user override, and
cancel the visualization characteristic modification in response to the user override.

21. An apparatus comprising:
logic to,
obtain an image associated with a front-facing camera of a system,
conduct a facial distance analysis on the image, and
modify a visualization characteristic of display content associated with the system based at least in part on the facial distance analysis.

22. The apparatus of claim 21, wherein the logic is to,
identify one or more facial features in the image, and
make a facial distance determination based at least in part on the one or more facial features.

23. The apparatus of claim 22, wherein the logic is to:
conduct a calibration of the system to obtain a calibration facial distance, and
store the calibration facial distance and one or more calibration display settings to a memory location, wherein the facial distance determination is to be made relative to the calibration facial distance.

24. The apparatus of claim 22, wherein the logic is to increase a text size of the display content if the facial distance determination and a calibration facial distance indicate that a user is farther away from the display.

25. The apparatus of claim 22, wherein the logic is to decrease a text size of the display content if the facial distance determination and a calibration facial distance indicate that a user is closer to the display.

26. The apparatus of claim 22, wherein the one or more facial features are to include at least one of a facial width, a facial height, a facial area, an eye width and an eye separation.

27. The apparatus of claim 21, wherein the logic is to modify an amount of the display content based at least in part on the facial distance analysis.

28. The apparatus of claim 21, wherein the logic is to modify a display intensity associated with the system based at least in part on the facial distance analysis.

29. The apparatus of claim 21, wherein the logic is to,
detect eyewear in the image, and
adjust the visualization characteristic modification in response to detecting the eyewear.

30. The apparatus of claim 21, wherein the logic is to,
receive a user override, and
cancel the visualization characteristic modification in response to the user override.
